(19) United States
(12) Patent Application Publication
(10) Pub. No.: US 2007/0216952 A1
(43) Pub. Date: Sep. 20, 2007

(54) Image processing system and method for halftoning tuning

(75) Inventors: Guo-Tai Chen, Taipei (TW); Hui-Jan Chien, Taipei (TW)

Correspondence Address: BRUCE H. TROXELL, SUITE 1404, 5205 LEESBURG PIKE, FALLS CHURCH, VA, 22041, US

(73) Assignee: Destiny Technology Corporation

(21) Appl. No.: 11/377,306

(22) Filed: Mar. 17, 2006

(51) Int. Cl. G06K 15/00

(52) U.S. Cl. 358/3.06

(57) ABSTRACT

An image processing system and method using the technique of halftoning. It first inputs into a second printer the image color scale data of a standard color test chart, on which the second printer performs halftoning using its built-in halftone table, in order to output a set of second image color level data. Next, it obtains a host printer function according to the image color scale data and the second image color level data and then establishes a correlation function between the host printer function and the standard function, according to which the halftone table is modified to become a dithered halftone table, bringing the subsequent print quality of the second printer closer to that of the standard function.

### BACKGROUND OF THE INVENTION

1. Field of the Invention

The present invention relates to an image processing method and system, particularly to image processing method and system for using in a printer having built-in halftone tables.

2. Description of the Prior Art

Generally speaking, before actual print-out, a printer has to do some pre-print processing known as halftoning to assimilate and convert the image data it has received.

An image as defined by a printer is constituted by a plurality of densely clustered pixels, each pixel having a corresponding gray scale value ranging from 0 to 255.

Halftoning is done by converting the data contained in each pixel of the image according to a halftone table, formed by the directional characteristics of the four printing colors: C-M-Y-K, which is a prior art technique of which we will make no more description than is necessary.

To illustrate, the following is a table consisting of a group of color level data to be input into a printer. Corresponding to an image, these data contain a plurality of pixels as well as their corresponding grayscale value.

TABLE 1

| | | | |
|---|---|---|---|
| 0 | 70 | 70 | 70 |
| 0 | 70 | 70 | 70 |
| 0 | 0 | 70 | 70 |
| 0 | 70 | 70 | 70 |

Table 2 is a halftone table consisting of a group of corresponding dither balues: 144-128-112-96-160-16-0-80-176-32-48-64-192-208-224-255.

TABLE 2

| | | | |
|---|---|---|---|
| 144 | 128 | 112 | 96 |
| 160 | 16 | 0 | 80 |
| 176 | 32 | 48 | 64 |
| 192 | 208 | 224 | 255 |

By comparing the corresponding grids of Table 1 with those of Table 2, we obtain Table 3. When the grey scale value of a grid in Table 1 is smaller than the halftone value in the corresponding grid of Table 2, the corresponding grid of Table 3 is assigned a value of 0. When the grey scale value of a grid in Table 1 is lager than the halftone value in the corresponding grid of Table 2, the corresponding grid of Table 3 is assigned a value of 1. Thus, values in Table 3, from top left to bottom right, will run as follow: 0(0<144), 0(70<128), 0(70<112), 0(70<96), 0(0<160), 1(70>16), 1(70>0), 0(0<80), 0(0<176), 0(0<32), 1(70>48), 1(70>64), 0(0<192), 0(70<208), 0(70<224), 0(70<255) . . . and so on.

TABLE 3

| | | | |
|---|---|---|---|
| 0 | 0 | 0 | 0 |
| 0 | 1 | 1 | 0 |
| 0 | 0 | 1 | 1 |
| 0 | 0 | 0 | 0 |

The printer will decide to print or not to print out the data obtained in each grid of Table 3 according to the value received being 0 or 1, thus forming the picture to be printed out.

Please refer to FIG. 1 and FIG. 2. FIG. 1 shows two curves illustrating the print quality of a prior art standard printer. FIG. 2 is a standard color test chart 2. If we input the image color scale data as shown in the standard color test chart 2 in FIG. 2 into a standard printer (hereinafter referred to as the first printer), and have the first printer do the halftoning according to the aforementioned halftone table to output a first image color level data, and subsequently make the image color scale data as vertical coordinates and the above first image color level as horizontal coordinates, we can obtain a standard function, which is shown as the curve F(x)n in FIG. 1.

However, if we choose a non-standard printer (hereinafter referred to as the second printer) to print out the image, when we input the same image color scale data of the standard color test chart 2, after the same halftoning according to the same halftone table, the second image color level data output will be somewhat different from the first image color level data of the first printer, with printed-out image being either too dark or too light and the grayscale distribution even being non-linear. From the image color scale data (vertical coordinates) and the second image color level data (horizontal coordinates ) of FIG. 1 we can obtain a host printer function, which is shown as the curve G(x) in FIG. 1. As can be easily seen from FIG. 1, G(x) is significantly deviated from F(x).

The purpose of the present invention is thus to provide an image processing system and method for a printer using the halftoning technique to process images, so that the above problem(s) may be solved.

### SUMMARY OF THE INVENTION

The purpose of the present invention is to provide an image processing system and method for a printer using the halftoning technique to process images to modify the images printed by a non-standard printer, making the quality of such images closer to that of images printed out by a standard printer.

The present invention relates to an image halftoning/processing system, which, by making use of a standard function, modifies the print quality of a second printer. The image processing system comprises a second halftoning module, a function generation module, a correlation generation module, and a dithering module.

The above-mentioned second halftoning module is installed in a second printer, which, after receiving image color scale data from the standard color test chart, first performs the halftoning process over these data according to a halftone table and then prints out the set of second image color level data.

The function of the above-mentioned function generation module is to obtain a host printer function according to the image color scale data and the second image color level data, whereas that of the correlation generation module is to correlate the host printer function with the standard function.

The function of the dithering module is to modify the above-mentioned halftone table, according to the correlation function, to establish a dithered halftone table and, subsequently, input the image color scale data of the standard color test chart into the second printer, in which the halftoning process is done according to the halftone table, before a set of third image color level data is printed out.

By the above process, the print quality as printed by the third image color level data is close or equal to that as printed out by the standard function.

Thus, by installing the present invention's image halftoning system and method in a printer, and by making use of the system and method's correlation generation module to obtain a correlation function, according to which a dithering module subsequently modifies the halftone table to establish a dithered halftone table, the host printer function can be made to resemble the standard function to greater degree, and the image printed out by a non-standard printer can be modified and made to rival the image quality as printed out by a standard printer.

### BRIEF DESCRIPTION OF THE DRAWINGS

The present invention will be more fully understood from the detailed description, which will be given hereinafter, with the aid of the illustrations below:

FIG. 1 shows the curve illustrating the print quality of the prior art standard printer.

FIG. 2 shows the standard color test chart.

FIG. 3 illustrates how the present invention's image processing system works.

FIG. 4 shows the entire process of the present invention's image processing method.

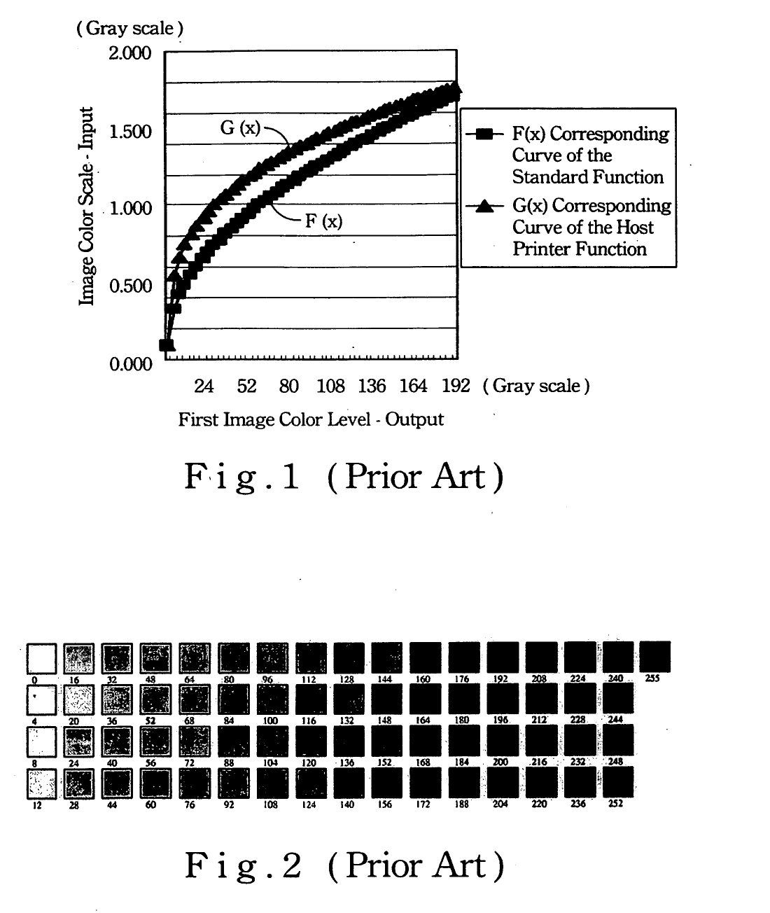

### DESCRIPTION OF THE PREFERRED EMBODIMENT

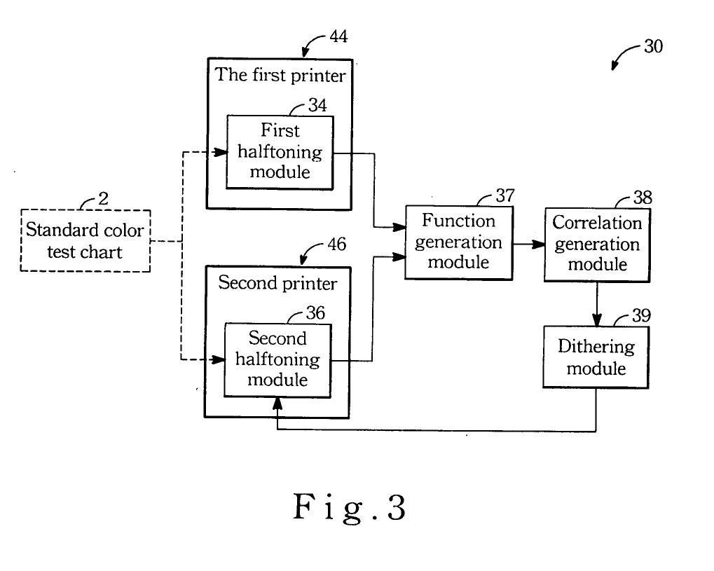

Please refer to FIG. 3. FIG. 3 illustrates how the present invention's image processing system 30 works. The present invention relates to an image halftoning/processing system 30, which comprises a first halftoning module 34, a second halftoning module 36, a function generation module 37, a correlation generation module 38, and a dithering module 39.

The first halftoning module 34 is installed in a first printer 44, which performs the process of halftoning on the image color scale data of the standard test chart 2 inputting into a first printer 44, according to the first printer's 44 halftone table, in order to output a first image color level data.

The second halftoning module 36 is installed in a second printer 46, which performs the process of halftoning on the image color scale data of the standard color test chart 2 input into a second printer 46 according to the second printer's 46 halftone table, in order to output a second image color level data.

The function of the function generation module 37 is to obtain a standard function F(x) according to the image color scale data and the first image color level data. The function generation module 37 also obtains a host printer function G(x) according to the image color scale data and the second image color level data.

The function of the correlation generation module 38 is to establish a correlation function between the host printer function and the standard function.

The function of the dithering module 39 is to modify the second printer's 46 halftone table, according to the correlation function, to establish a dithered halftone table, and then, input the standard color test chart's image color scale data into the second printer 46, on which the second printer 46 performs the halftoning process according to the halftone table in order to output a third image color level data, making the print quality of the third image color level data close to that as printed out by the standard function and that the print quality of a non-standard printer may approach or even be equal to the print quality as printed out by a standard printer.

Additionally, the standard function F(x) can be set as default. If such be the case, the standard function generation step can be skipped from the above described process. The example given above, in which the system uses the first printer 44 to obtain the standard function F(x), is merely an embodiment of the present invention.

Furthermore, the acquisition of the correlation function is explained below:

Suppose G(x)=the host printer function, and F(x)=the standard function,

In practice, representative functions of both the above can be developed from performing regression analyses on the quality levels of a multitude of actual print-out samples.

Suppose f(x)=the correlation function between the host printer function G(x) and the standard function F(x)=F−1(G(x)).

If f(x)=(x/255)1/2*255, the following is an example showing how to use the correlation function to modify the dither values on the halftone table of Table 2.
f(0)=0
f(16)=64
f(32)=90
f(48)=107
f(64)=128
f(80)=143
f(96)=156
f(112)=169
f(128)=181
f(144)=192
f(160)=202
f(176)=212
f(192)=221
f(208)=230
f(224)=239
f(255)=255

Thus, Table 2 is made into the following halftone table of Table 11:

TABLE 11

| | | | |
|---|---|---|---|
| 192 | 181 | 169 | 156 |
| 202 | 64 | 0 | 143 |
| 212 | 90 | 107 | 128 |
| 221 | 230 | 239 | 255 |

By comparing the halftone table of Table 1 with that of Table 13, a new print quality table as the following Table 13 is shown.

TABLE 13

| | | | |
|---|---|---|---|
| 0 | 0 | 0 | 0 |
| 0 | 0 | 1 | 0 |
| 0 | 0 | 0 | 0 |
| 0 | 0 | 0 | 01 |

Table 1 contains the aforementioned image color scale data, and Table 3 the second image color level data. Referring to Table 1 and Table 3, we obtain the host printer function G(x). Table 11 is the modified halftone table. Table 13 contains the third image color level data, whose print-out quality approaches that as printed out by the standard function. In other words, the new function acquired through Table 1 and Table 13 is closer to the standard function F(x) than is the host printer function G(x), so that its print quality is closer to the ideal.

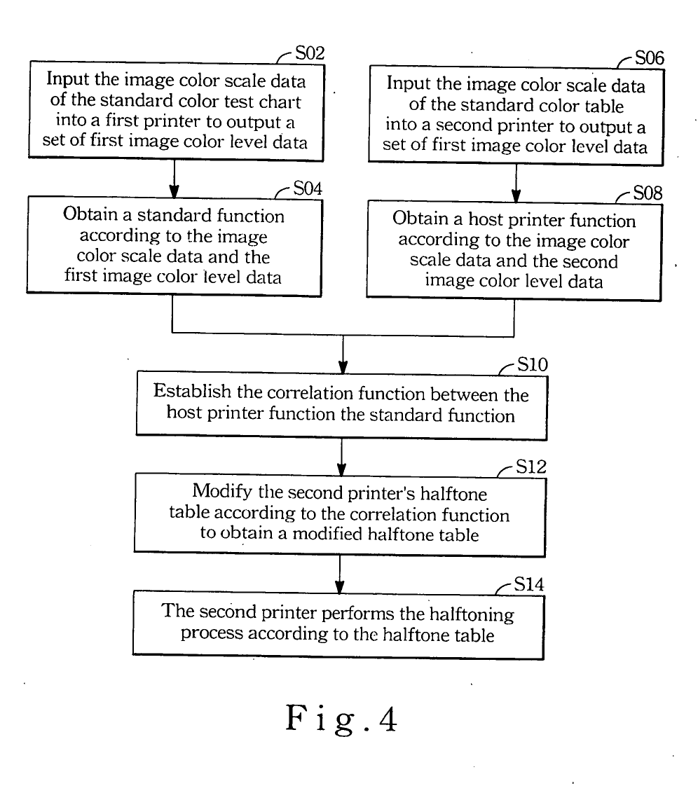

The present invention also relates to an image processing method as implemented by the image processing system 30. Please refer to FIG. 4. FIG. 4 illustrates the entire process of the present invention's image processing method. The process comprises the following steps:

Step S02: Input the image color scale data of the standard color test chart 2 into a first printer 44; the first printer 44 then uses its built-in halftone table to do halftoning on the above-mentioned data in order to output a set of first image color level data.

Step S04: Obtain a standard function according to the image color scale data and the first image color level data.

Step S06: Input the image color scale data of the standard color test chart 2 into a second printer 46; the second printer 46 then uses its built-in halftone table to do halftoning on the above-mentioned data in order to output a set of first image color level data.

Step S08: Obtain a host printer function according to the image color scale data and the second image color level data.

Step S10: Establish the correlation function between the host printer function and the standard function.

Step S12: Modify the second printer's 46 halftone table according to the correlation function to obtain a modified halftone table.

Step S14: Input the image color scale data of the standard color test chart into the second printer 46, on which the second printer 46 performs the halftoning process according to the halftone table in order to output a third image color level data, making the print quality of the third image color level data close to that as printed out by the standard function. In other words, the new function derived from the third image color level data and the image color scale data is closer to the standard function than is the host printer function; even completely identical with the standard function.

Thus, by installing the present invention's image halftoning system 30 and method in a printer, and by making use of the system and method's correlation generation module 38 to obtain a correlation function, according to which a dithering module 39 subsequently modifies the halftone table to establish a dithered halftone table, the host printer function can be made closer to the standard function, and the image printed out by a non-standard printer can be modified and made to rival the image quality as printed out by a standard printer.

As is understood by a person skilled in the art, the foregoing preferred embodiment of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. An image processing method using the technique of halftoning, said method comprising the steps of:
picking up a standard function;
inputting into a second printer the image color scale data of a standard color test chart, on which said second printer performs halftoning according to its built-in halftone table;
obtaining a host printer function according to said image color scale data and said second image color level data;
obtaining the correlation function between said host printer function and said standard function;
modifying said second printer's halftone table according to said correlation function to obtain a modified halftone table; and
inputting into a second printer the image color scale data of a standard color test chart, on which said second printer performs halftoning according to its built-in halftone table in order to output a set of third image color level data, making said third image color level data's print quality close to that of the standard function's print quality

2. The image processing method as in claim 1, wherein said standard function is obtained through the following steps:
inputting into a first printer the image color scale data of a standard color test chart, on which said first printer performs halftoning according to its built-in halftone table in order to output a set of first image color level data; and
obtaining a standard function according to said image color scale data and said first image color level data.

3. The image processing method as in claim 1, wherein said standard function is F(x), said host printer function is G(x), and said correlation function is F⁻¹(G(x)).

4. An image processing system using the technique of, which modifies the print quality of a second printer according to a standard function; wherein said image color scale data of said standard color test chart is input into a said second printer and is halftoned in said second printer, according to said dithered halftone table, in order to output a third image color level data, so that the print-out quality of said third image color level data approaches that of said standard function; said image processing system further comprising
a second halftoning module, installed in said second printer to perform said halftoning process, according to a halftone table, on said image color scale data of said standard color test chart which has been input into said second printer, in order to output a second image color level data;
a function generation module, used to obtain a host printer function according to said image color scale data and said second image color level data,
a correlation generation module, to obtain the correlation function between said host printer function and said standard function.
a dithering module, to modify said second printer's halftone table, according to said correlation function, in order to obtain a dithered halftone table;

5. The image processing system as in claim 4, wherein said function generation module obtains a standard function according to said image color scale data and said first image color level data; said image processing system further comprising:
a first halftoning module, installed in a first printer, used to input into said first printer said image color scale data of said standard color test chart, on which said first printer performs the process of halftoning according to a built-in halftone table in order to output a first image color level data;

6. The image processing system as in claim 4, wherein said standard function is F(x), said host printer function is G(x), and said correlation function is F⁻¹(G(x)).
